(19) United States
(12) Patent Application Publication
(10) Pub. No.: US 2014/0178054 A1
(43) Pub. Date: Jun. 26, 2014

(54) VEHICLE HEATER AND METHOD FOR PRODUCING A VEHICLE HEATER

(71) Applicant: BorgWarner BERU Systems GmbH, Ludwigsburg (DE)

(72) Inventors: Michael Luppold, Dettingen (DE); Alexander Dauth, Maulbronn (DE); Klaus Lehmann, Oberderingen (DE)

(21) Appl. No.: 14/132,753

(22) Filed: Dec. 18, 2013

(30) Foreign Application Priority Data
Dec. 21, 2012 (DE) 10 2012 112 837.5

(51) Int. Cl. B60H 1/22; B23P 11/00

(52) U.S. Cl. CPC B60H 1/2225; B23P 11/00
USPC 392/360; 29/428

(57) ABSTRACT

The invention relates to electric vehicle heater comprising at least one tube, in which at least one heating element is arranged, and at least one heat transfer panel, which is fastened to the tube and has a plurality of flow openings for an airflow to be heated. According to the invention, the heat transfer panel is a component that sits in a groove in the tube, said groove running in the longitudinal direction of the tube. The invention also relates to a method for producing a vehicle heater, wherein at least one heating element is arranged in a tube and at least one heat transfer panel is inserted into a groove on an outer side of the tube.

### RELATED APPLICATIONS

This Application claims priority to DE 10 2012 112 837.5, filed Dec. 21, 2012, the entire disclosure of which is hereby incorporated herein by reference in its entirety.

### BACKGROUND

The invention is based on a vehicle heater comprising at least one tube, in which at least one heating element is arranged, and at least one heat transfer panel, which is fastened to the tube and has a plurality of flow openings for an airflow to be heated. Such a vehicle heater is known from DE 10 2009 013 927 A1.

The known vehicle heater is produced from an extruded profile, which comprises a plurality of tubes which are connected by heat transfer panels and in which ceramic heating elements are arranged. Flow openings for an airflow to be heated are cut out from the heat transfer panels of the extruded profile.

### SUMMARY

The present disclosure specifies a way in which vehicle heaters can be produced more cost effectively.

In a vehicle heater according to this disclosure, one or more heat transfer panels are fastened to a heating tube. Each heat transfer panel is a separate component, which sits in a groove of the tube, said groove running in the longitudinal direction of the tube, and has a plurality of flow openings, preferably at least 10 flow openings, for an airflow to be heated. Vehicle heaters can thus be produced by manufacturing heat transfer panels and tubes separately and then fastening them to one another by inserting a heat transfer panel into a groove that runs in the longitudinal direction of the tubes. This has the advantage that the number of tubes and heat transfer panels of a motor vehicle heater can be varied without difficulty in order to produce a vehicle heater consistent with given requirements. The same parts can be used for different vehicle heaters in accordance with the requirements of different car manufacturers. Tool costs for producing these parts can therefore be allocated to a much larger number of parts, and therefore the unit costs for vehicle heaters can be reduced.

In an advantageous refinement of this disclosure, the groove is undercut and the heat transfer panel engages in the undercut of the groove. A form fit can thus be achieved between tube and heat transfer panel, such that the heat transfer panel is movable only in the longitudinal direction of the groove, but cannot be removed from the tube by a force perpendicular to the longitudinal direction of the groove. A heat transfer panel is thus attached by inserting it into the groove in the longitudinal direction of the tube. Alternatively or additionally, the heat transfer panel can also be held in the groove in a clamped or force-locked manner.

The undercut groove, together with a heat transfer panel sitting therein, may form a dovetail connection for example. A simpler possibility with lower manufacturing outlay is a groove that is L-shaped in cross section. A matching heat output panel can be produced cost effectively as a perforated sheet which has a longitudinal edge that is positioned by means of bending.

In order to improve the heat contact between a tube and the heating element or the heating elements contained therein, the tube can be compressed once the heating element(s) has/have been introduced. The tubes of a vehicle heater according to this disclosure may be compressed before the heat output panels are attached. On the one hand the tubes without heat output panels can be easily handled, and on the other hand the orientation of the heating elements in the tubes of a vehicle heater according to this disclosure can be freely selected. In the case of a vehicle heater comprising plate-shaped heating elements, the heating elements can be aligned so that one of the two large sides faces the heat output panel, that is to say the geometrical plane of the plate of each heating element is oriented transverse, preferably perpendicular, to the plane of a heat transfer panel fastened to the tube. Heat generated by the heating element can then be removed particularly efficiently via the heat transfer panel.

In a further advantageous refinement of this disclosure, the tube has two mutually opposed narrow sides and two mutually opposed broad sides, wherein the heat transfer panel is fastened to one of the broad sides. For example, the tube may have a substantially rectangular cross section. Since the heat transfer panels are fastened to the broad sides of the tubes, the heat output to the airflow to be heated can be improved. This is dependent on the fact that the area of the vehicle heater against which the airflow flows is formed to a lesser extent by the tube or the tubes and to a greater extent by the heat output panels having flow openings. The flow resistance of the vehicle heater can therefore advantageously be reduced if heat transfer panels are fastened to broad sides of the tubes.

The groove in which a heat transfer panel sits may have a width that is smaller than the thickness of the tube, for example. If the groove is arranged in a broad side of the tube, the width of the groove is then smaller than the width of the narrow side.

In a further advantageous refinement of this disclosure, each tube of the vehicle heater has a plurality of grooves arranged side by side for heat output panels. A plurality of heat output panels can thus be fastened in succession in the flow direction to a heating tube as required in order to adapt to given requirements the flow resistance and the surface available for heat output. A plurality of grooves that run parallel to one another in the longitudinal direction of the tube are preferably arranged on one side of a tube, that is to say side by side.

A plate that has a plurality of flow openings for an airflow to be heated is used as a heat transfer panel of a vehicle heater according to this disclosure. The heat transfer panel preferably has a plurality of flow openings that are arranged side by side transverse to the longitudinal direction of the tube.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic illustration of a vehicle heater; and

FIG. 2 shows a heating tube of the vehicle heater shown in FIG. 1.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of the present invention.

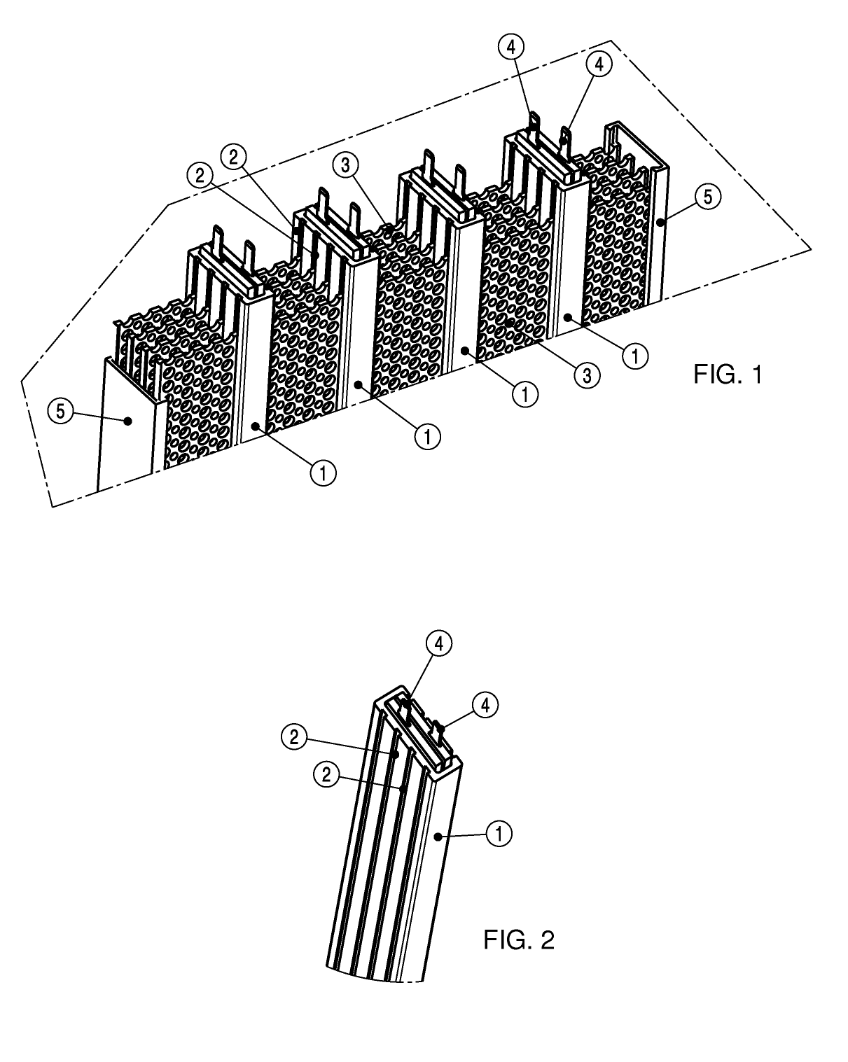

An electric vehicle heater for heating an airflow is illustrated in FIG. 1 and can be used for example in an air-conditioning system or as an additional heater for heating a passenger compartment. The vehicle heater consists of a plurality of tubes 1, in each of which one or more ceramic heating elements, for example PTC heating elements, that may be based on barium titanate, is/are arranged. The tubes 1 are preferably arranged parallel to one another and can be produced for example by extrusion. The tubes 1 consist of metal, for example of an aluminum alloy.

The tubes 1, on two opposite outer sides, have one or more grooves 2, which run in the longitudinal direction of the tubes 1. Heat transfer panels 3, which each have a plurality of flow openings for an airflow to be heated, sit in these grooves 2. The individual heating tubes 1 are thus connected by heat transfer panels 3 arranged therebetween. Each heat transfer panel is a one-piece component which has a plurality of flow openings, preferably at least ten flow openings. Perforated sheets for example can be used as heat output panels 3.

The grooves 2 have a depth that is smaller than the wall thickness of the tubes 1. In other words, the tube wall, in which a groove 2 is arranged, forms a base of the groove 2. The grooves 2 therefore do not penetrate the tube walls.

The grooves 2 are undercut. The heat transfer panels 3 each engage in the undercut of the grooves 2. A form-fitting connection thus exists between the heat transfer panels 3 and the tubes 1. The undercut of the grooves 2 can be shaped for example such that the groove 2 forms a dovetail connection to a heat output panel 3 sitting therein.

The vehicle heater shown in FIG. 1 is produced by introducing one or more plate-shaped heating elements into a tube 1 and by inserting heat output panels 3 via their longitudinal edges into the grooves 2 on the outer sides of the tubes 1.

The heating element or heating elements is/are electrically contacted in the tubes 1 by contact sheets 4, which protrude from one end of the tubes 1. If the tubes 1 themselves are used as a ground contact for the heating elements, a single contact sheet 4, which is insulated by the tube 1 and electrically contacts the heating element or the heating elements, is sufficient per tube. Otherwise a second contact sheet is needed for each tube 1.

Heating elements, contact sheets and insulation material can be inserted for example as a module with an assembly frame made of plastic into a heating tube 1. Once the heating elements have been introduced into a tube 1, said tube can be compressed in order to improve the heat coupling between the heating element or heating elements and the tube 1.

The tubes 1 are approximately rectangular in the illustrated embodiment, that is to say have two mutually opposed narrow sides and two mutually opposed broad sides. The heat transfer panels 3 are fastened here to the broad sides. Accordingly, the grooves 2 are located in the broad sides of the tubes 1. The ceramic heating elements can be plate-shaped and oriented in the tubes such that the plate plane thereof is oriented perpendicular to the heat output panels 3. The plate planes of the heating elements then face the broad sides of the tubes 1.

In the illustrated embodiment, the tubes 1 each have a plurality of grooves which are arranged side by side and which can each receive a heat transfer panel 3. In the case of the illustrated vehicle heater, a plurality of heat transfer panels 3 are arranged in succession in the flow direction, which enables an improved removal of heat.

On its sides, the vehicle heater has terminating strips 5 that cover the longitudinal edges of heat output panels arranged in succession. The terminating strips can be fastened to the heat output panels 3, for example in that the terminating strips 5, similarly to the heating tubes 1, also have grooves 2 into which longitudinal edges of the heat output panels are fitted. The terminating strips may also be held by a base for example, in which they and the heating tubes are fitted, and/or by an attachment fitted onto the heating tubes 1.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electric vehicle heater, comprising:
at least one tube, in which at least one heating element is arranged; and
at least one heat transfer panel, which is fastened to the tube and has a plurality of flow openings for an airflow to be heated;
wherein the heat transfer panel sits in a groove in the tube, said groove running in the longitudinal direction of the tube.

2. The vehicle heater according to claim 1, wherein the groove is undercut.

3. The vehicle heater according to claim 2, wherein the groove forms a dovetail connection of tube and the heat transfer panel.

4. The vehicle heater according to claim 2, wherein the groove has an L-shaped cross section.

5. The vehicle heater according to claim 1, wherein the heat transfer panel is formed from sheet metal.

6. The vehicle heater according to claim 1, wherein the heat transfer panel has a plurality of flow openings that are arranged side by side transverse to the longitudinal direction of the tube.

7. The vehicle heater according to claim 1, wherein the heat transfer panel is an elongate plate having a longitudinal edge arranged in the groove.

8. The vehicle heater according to claim 1, wherein the tube has a plurality of grooves arranged side by side on at least one side of the tube, said grooves being configured to receive heat transfer panels.

9. The vehicle heater according to claim 8, further comprising a plurality of heat transfer panels each sitting in a respective one of the grooves.

10. The vehicle heater according to claim 9, wherein a lateral terminating strip covers longitudinal edges of several heat transfer panels.

11. A method for producing a vehicle heater, comprising:
providing at least one tube;
arranging at least one heating element in the at least one tube; and
inserting at least one heat transfer panel into a groove of the tube.

12. The method of claim 11, further comprising providing a plurality of openings in the heat transfer panel for an airflow to be heated.

13. The method of claim 12, wherein the at least one heat transfer panel comprises a plurality of heat transfer panels and the groove comprises a plurality of grooves, said method further comprising inserting each heat transfer panel into respective ones of the grooves.

14. The method of claim 13, further comprising covering longitudinal edges of the heat transfer panels with a lateral terminating strip.
